(19) United States
(12) Patent Application Publication
(10) Pub. No.: US 2012/0255619 A1
(43) Pub. Date: Oct. 11, 2012

(54) REMOTE-CONTROLLED, WATER DISPENSING SYSTEM

(76) Inventors: Michael Librus, Netanya (IL); Ran Hirsch, Tel Aviv (IL)

(21) Appl. No.: 13/508,810

(22) PCT Filed: Nov. 11, 2010
(86) PCT No.: PCT/IB10/55129

§ 371 Date: Jun. 27, 2012

Related U.S. Application Data
(60) Provisional application No. 61/260,014, filed on Nov. 11, 2009.

(51) Int. Cl. E03B 1/00; F16K 31/02

(52) U.S. Cl. 137/1; 251/129.01

(57) ABSTRACT

A remote-controlled, water dispensing system directed at reducing water wastage by way of a system facilitating efficient use of water during daily kitchen related and personal hygiene practices.

### FIELD AND BACKGROUND OF THE INVENTION

The present invention relates to water conservation and, in particular, it is concerned with a remote-controlled, water dispensing system directed at facilitating efficient use of water during daily, kitchen-related and personal hygiene practices.

Rising water costs across the world spurs an increasing interest in water conservation methods and improving efficiency of existent water usage practices. Furthermore, there is a growing interest worldwide in minimizing the likelihood of transmitting disease and illness by way of communal water faucets and sinks. Remote-controlled, water dispensing addresses both of these needs by enabling a user to dispense water for the few moments in which the water is actually needed instead of allowing the water to flow. Furthermore, remote control enables multiple users to dispense water with greatly reduced contact with water dispensing facilities thereby increasing the hygienic state of these facilities

US Application 20050167625 teaches a remote-controlled, water valve for turning on the water when a user is standing at a significant distance from the water valve. The shortcoming of such an arrangement is that the transmitter is implemented as a distinct device requiring a user to set down another device that he may be holding while involved in personal hygiene practices near a sink. After setting down a toothbrush, for example, his hands are then freed up to actuate the transmitter. This practice is cumbersome and does not offer any benefit to a user standing near a sink.

There exist remote-controlled, bulky retrofit infra-red systems that enable a user to dispense water without touching the faucet knobs. However, these devices are cumbersome and block direct access to the water stream from above.

Therefore there is a need for remote-controlled, non-obtrusive, water dispensing system facilitating efficient use of water during daily kitchen related and personal hygiene practices.

### SUMMARY OF THE INVENTION

The present invention is remote-controlled, water dispensing system facilitating efficient use of water during daily, kitchen-related and personal hygiene practices.

According to the teachings of the present invention there is provided a water dispensing system comprising: (a) a receiver-actuated water valve connected to a water supply in fluid connection with a water tap; and (b) a submersible, hand-held device used in conjunction with tap water; and (c) a transmitter in wireless communication with the remotely-actuated water valve, the transmitter being connected to the device, so as to enable a user holding the device to dispense water from the water tap with the hand holding the device.

According to a further feature of the present invention, the transmitter includes a connection configuration for retrofitting the transmitter onto the hand-held device.

According to a further feature of the present invention, the connection configuration includes at least one clip configured to hold the transmitter on the hand-held device.

According to a further feature of the present invention, the connection configuration is selected from the group consisting of a suction arrangement and adhesive material.

According to a further feature of the present invention, the hand held device includes a toothbrush.

According to a further feature of the present invention, the hand held device includes a non-electric razor.

According to a further feature of the present invention, the hand-held device includes a sponge.

According to a further feature of the present invention, the device is selected from the group consisting of comb, hand peeler and water pitcher.

There is also provided according to the teachings of the present invention, a method for remotely dispensing water from water tap comprising:

(a) holding a submersible, hand-held device used in conjunction with tap water, wherein the device has a transmitter in wireless communication with a receiver-actuated flow valve configured to allow water flow from a water supply to a water tap; and (b) actuating the transmitter to dispense water from the water tap with a hand holding the device.

According to a further feature of the present invention, there is also provided closing the water valve by re-actuating the transmitter.

According to a further feature of the present invention, the transmitter includes a connection configuration for retrofitting the transmitter onto the device.

According to a further feature of the present invention, the connection configuration includes at least one clip configured to hold the transmitter on the device.

According to a further feature of the present invention, the connection configuration is selected from the group consisting of a suction arrangement and adhesive material.

According to a further feature of the present invention, the hand-held device includes a toothbrush.

According to a further feature of the present invention, the hand-held device includes a non-electric razor.

According to a further feature of the present invention, the hand-held device includes a sponge.

According to a further feature of the present invention, the hand-held device is selected from the group consisting of comb, hand peeler and water pitcher.

There is also provided according to the teachings of the present invention, a water dispensing system comprising: (a) a receiver-actuated water valve connected to a water supply in fluid connection with a water tap; (b) a bath mat; and (c) a foot-actuated transmitter in wireless communication with the remotely-actuated water valve, the transmitter being attached to a bath mat so as enable a user to dispense water from the water tap by stepping on the transmitter while standing on the bath mat.

### BRIEF DESCRIPTION OF THE DRAWINGS

The invention is herein described, by way of example only, with reference to the accompanying drawings, wherein:

FIGS. 1 and 2 are pictorial views of a toothbrush and hand-held razor, respectively, both fitted with a finger-activated transmitter for a remotely-controlled water valve.

FIG. 3 is an isometric, top view of a clip-on finger-activated transmitter for a remotely controlled water valve.

FIG. 4 is an isometric, exploded top view of the clip-on finger-activated transmitter of FIG. 3.

FIG. 5 is a schematic, side-view of a suction arrangement for a retrofit, finger-activated transmitter.

FIG. 6 is a schematic, side-view of an adhesive connection configuration for a retrofit, finger-activated transmitter.

FIGS. 7-9 are isometric, exploded, top and side views, respectively, of a sponge fitted with retrofit, finger-activated transmitter for a remotely controlling water valve.

FIGS. 10-13 are schematic, side views of a peeler, a pitcher, comb, and bath mat respectively, each fitted with an integral finger-activated transmitter for a remotely controlling water valve.

FIG. 14 is an isometric top view of remote-controlled water valve unit. operative remotely.

FIG. 15 is an isometric, exploded top view of the remote-controlled water valve unit.

FIG. 16 is a schematic, isometric side view of the deployed remote-controlled water valve unit.

### DESCRIPTION OF THE PREFERRED EMBODIMENTS

The present invention is remote-controlled, water dispensing system facilitating efficient use of water during daily, kitchen-related and personal hygiene practices. By way of example, while brushing one's teeth, the toothbrush needs to be rinsed periodically and each rinsing is rather short in duration, around one or two seconds. Typically after a first, two-second rinse, the brush is again rinsed for a couple of seconds, and so on a third and a fourth time. The repetitive need to open and close the faucet leads one to leave the water running throughout the entire period of brushing. It follows, then, that the water is running continuously for a couple of minutes for the sake of a few seconds of actual rinsing. Although water wastage resulting from a single two-minute brushing session may be insignificant; however, when repeated by every household member in every house at least once a day, the cumulative wastage becomes quite significant. Similar problems occur when using a non-electric razor, a peeler, and many other devices used daily in conjunction with water.

The present invention addresses this problem by providing finger-controlled, water dispensing thereby facilitating the dispensing of water in accordance with the few, moments in which water is really needed. At this point it is useful to define terms to be used though the document.
“Submersible” refers to items that are normally used in a manner in which they are at least partially submerged in water during use, like toothbrushes, non-electric razors, sponges, safety mats used in bathrooms, water pitchers, peelers, combs and similar items.
“Transmitter” refers to either finger-actuated or foot-actuated transmitters.
“Receiver-actuated water valve” refers to a water valve actuated by a solenoid linked to a receiver thereby making the valve responsive to transmissions received by the receiver.

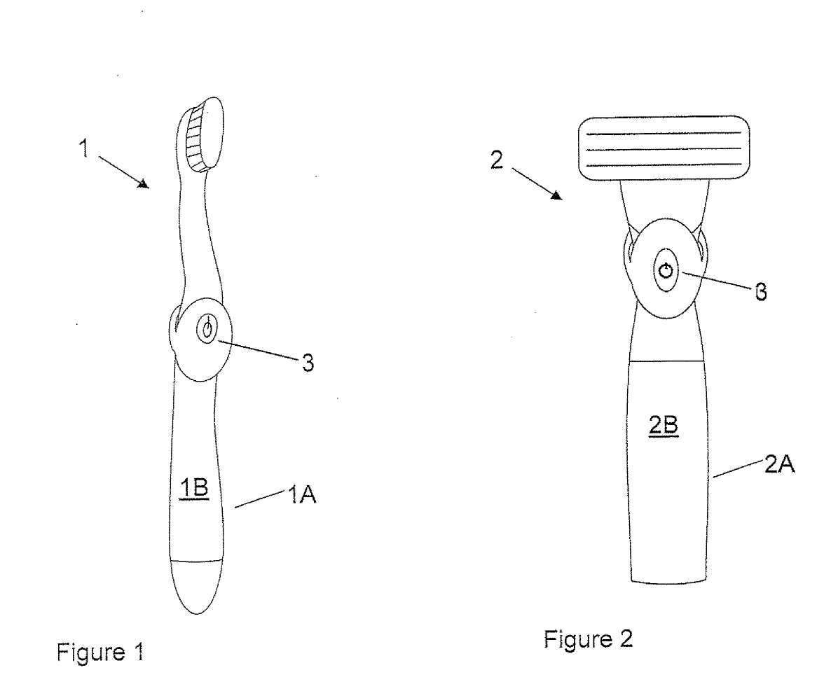

The principles and operation of the method according to the present invention may be better understood with reference to the drawings and the accompanying description. Turning now to the figures, FIGS. 1 and 2 depict a standard toothbrush 1 and a non-electric razor 2 having a finger-actuated transmitter 3 in wireless communication with a receiver configured to actuate water valves as will be discussed. Finger-actuated transmitter 3 is positioned on handles, 1A and 2A so as to facilitate finger actuation and in particular by the thumb; however, it should be noted that any position facilitating transmission by any one of a user's fingers is included within the scope of the present invention.

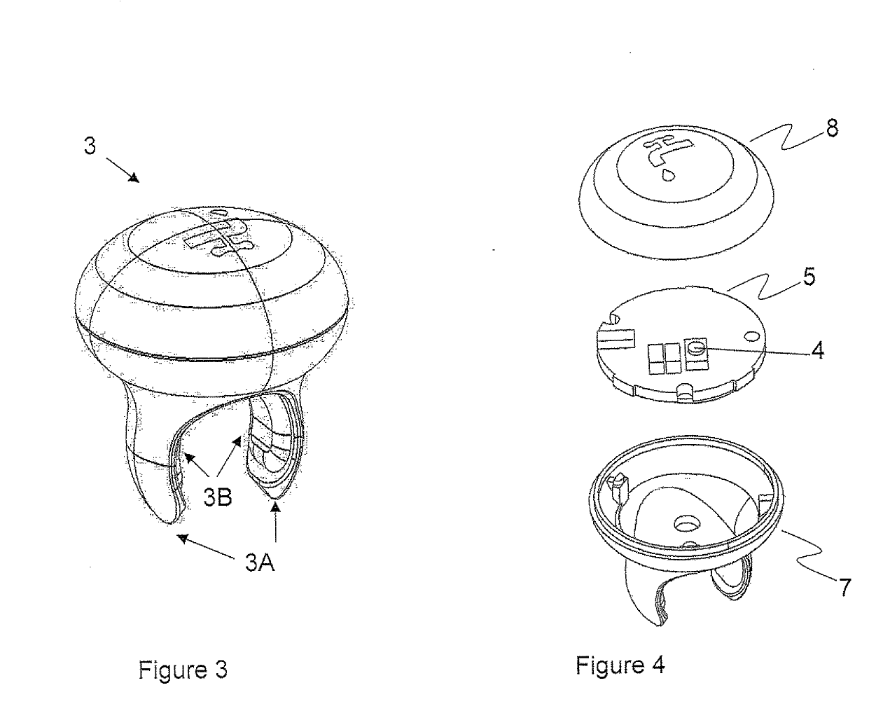

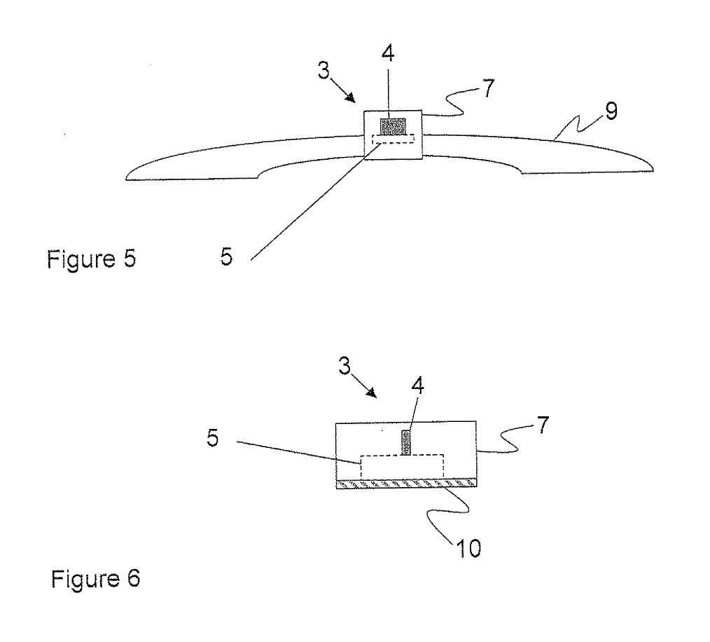

FIG. 3 depicts a non-limiting, exemplary connection configuration of a retrofit embodiment of finger-actuated transmitter 3 connected to the handle 1A of toothbrush 1 and the handle 2A of razor 2 (FIGS. 1 and 2) by way of a set of opposing, flexible clips 3A integrally formed into housing body 7. Clips 3A are spaced apart at distance slightly less than handle width 1B or 2B so that when handle is disposed in between clips 3A, they are spread apart slightly creating a resilient bias inwards thereby gripping handle 1A or 2A. The inner surface 3B of clips 3A is contoured to substantially match the particular handle surface contour of each device in a non-limiting, exemplary embodiment, to maximize contact surface thereby increasing the gripping ability of clips 3A. Referring to FIG. 4, finger-actuated transmitter 3 includes a polymeric housing body 7, a flexible cover 8, enclosing a push button switch 4 in operative connection with transmitter circuitry 5 and a power source 6 (not shown). Flexible cover 8 is constructed in a non-limiting, exemplary embodiment from flexible polymeric material configured to bend inwardly against push button switch 4 when pressed inwardly and to rebound into its original configuration afterwards; however, any material providing such functionality is included within the scope of the present invention. It should be appreciated that transmitter switches implemented as slide switches and dials are also included within the scope of the present invention. In a non-limiting, exemplary embodiment, the power source is implemented as a replaceable button battery; however, it should be also appreciated that non-replaceable batteries permanently soldered to transmitter circuitry 5 is included within the scope of the present invention. In a non-limiting, exemplary embodiment, transmitter circuitry 5 is operative on 1 micro amp, transmits at a frequency of RF 2.4 GHz, and has a range of around 2 meters. It should be noted that any frequency compliant with local transmission standards providing such functionality is included within the scope of the present invention.

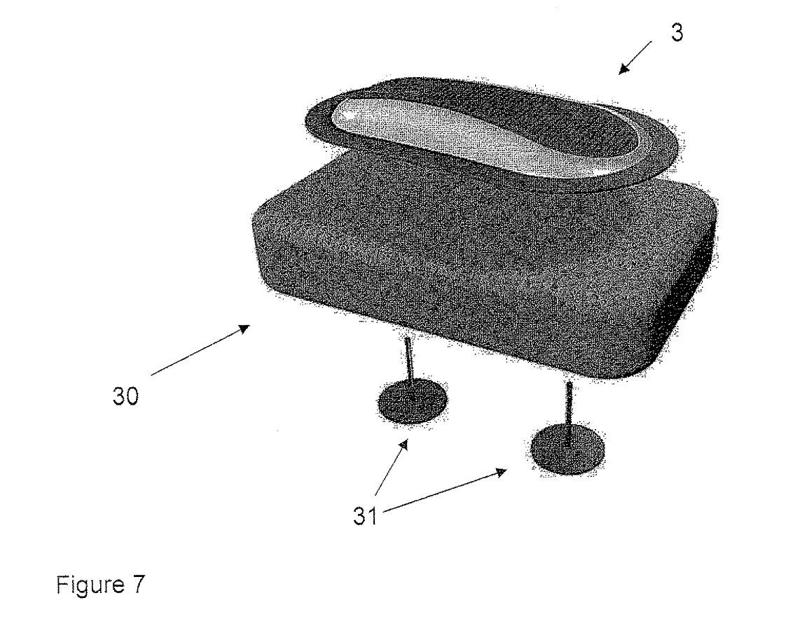

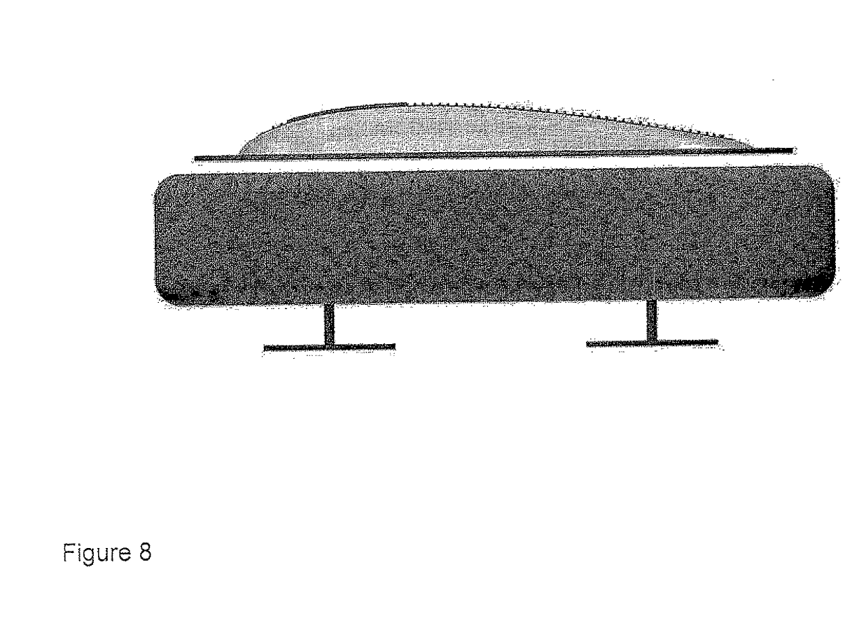

FIGS. 5 and 6 depict alternative connection configurations for a retrofit embodiment of transmitter 3. Specifically, FIG. 5 depicts a suction arrangement having a suction cup 9 fixed to transmitter housing body 7 to form a suction grip when pressed onto a handle surface. FIG. 6 depicts a connection arrangement implemented as an adhesive 10 disposed to the underside of transmitter housing body 7 to stick transmitter 3 to a handle surface. It should be appreciated that clip arrangements having a single clip are also included within the scope of the present invention as well as any configuration in which a retrofit transmitter is attached to a device used in conjunction with water as described above.

The present invention also discloses devices having a finger-actuated transmitter 3 integrally formed within the body of the device, specifically,

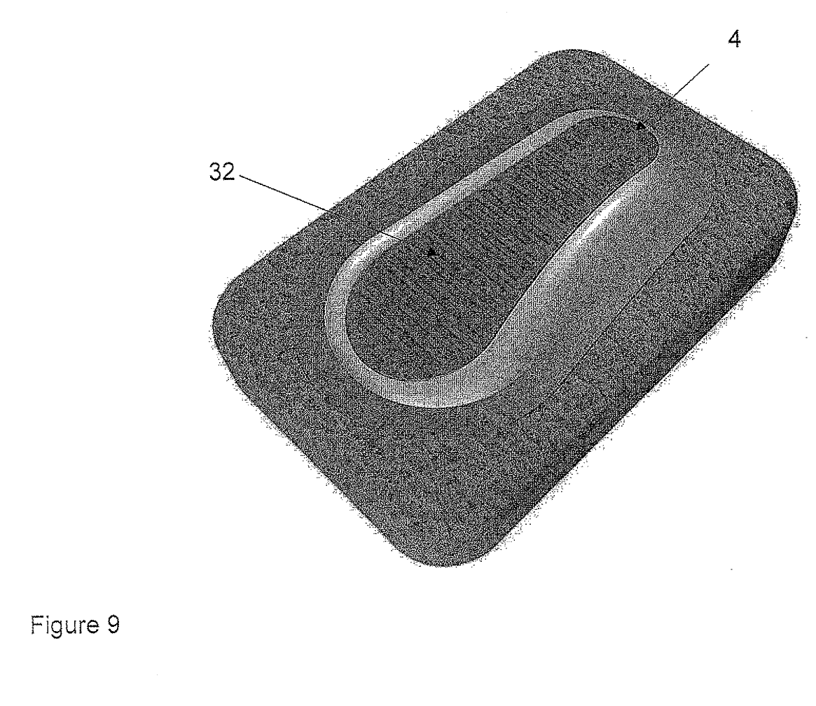

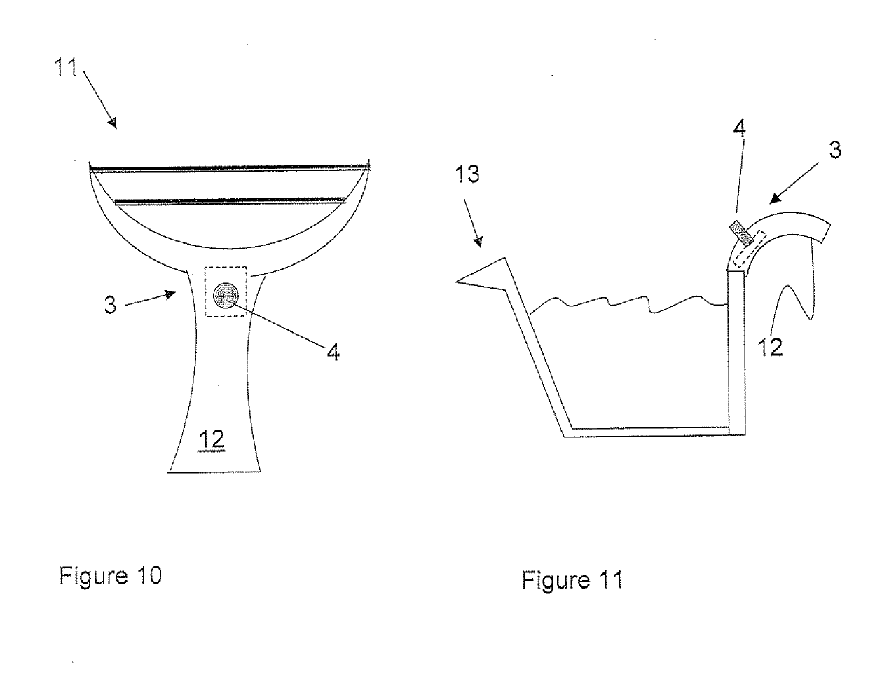

FIGS. 7-9 depict transmitter 3 adapted to retrofit to a sponge 30 by way of pegs 31 that penetrate the sponge and engage corresponding recesses (not shown) disposed in the underside of transmitter 3, thereby holding sponge 30 securely between transmitter 3 and pegs 31. A user holds sponge by way of grip 32 and dispenses tap water by actuating push button 4. A user changes the sponges by removing pegs 31 from the recesses and repeats the process for a new sponge. It should be appreciated that any connection configuration employed to attach transmitter 3 to sponge 30 is included within the scope of the present invention. FIGS. 10-13 depict devices generally used in conjunction with water. FIG. 10 depicts a peeler 11 having finger-actuated transmitter 3 disposed inside handle 12 in a location enabling a user to comfortably actuate push button switch 12A with a finger of the hand in which is holding the device as described above. Similarly, as shown in FIGS. 11 and 12, water pitcher 13 and comb 14 are fitted with an integral finger-actuated transmitter 3 inside of handle 12 enabling a user to easily actuate finger-actuated transmitter 3 by way of push button 12A. These devices include a disposable battery disposed in the body of the device to power the finger-actuated transmitter 3 in a non-limiting, exemplary embodiment. FIG. 13 depicts a bath mat 35 having transmitter 33 embedded inside mat 35. Mat 35 is typically used in conjunction with bathtubs and is placed on the bathtub floor or next to a bathtub the bathroom floor to prevent slipping. A foot-actuated transmitter 33 is disposed inside mat 35 in a manner enabling a user standing on mat 35 to dispense water by steeping on push button 4 inside mat 35. It should be noted that embodiments in which mat 35 is constructed from other water resilient materials is included within the scope of he invention as well a embodiments in which transmitter 33 is encased in a water proof material and connected to the top or to the underside of mat 35. It should be noted that all device totally submerged in water during the course of their normal use, transmitter 3 is configured to be waterproof in non-limiting, exemplary embodiments.

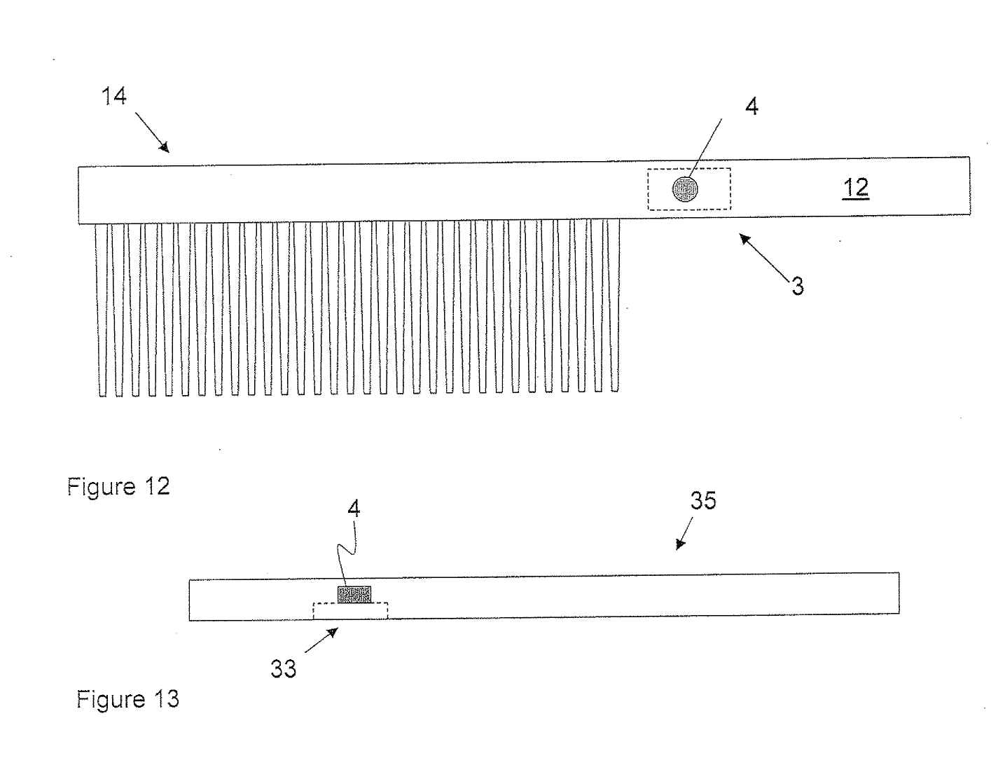

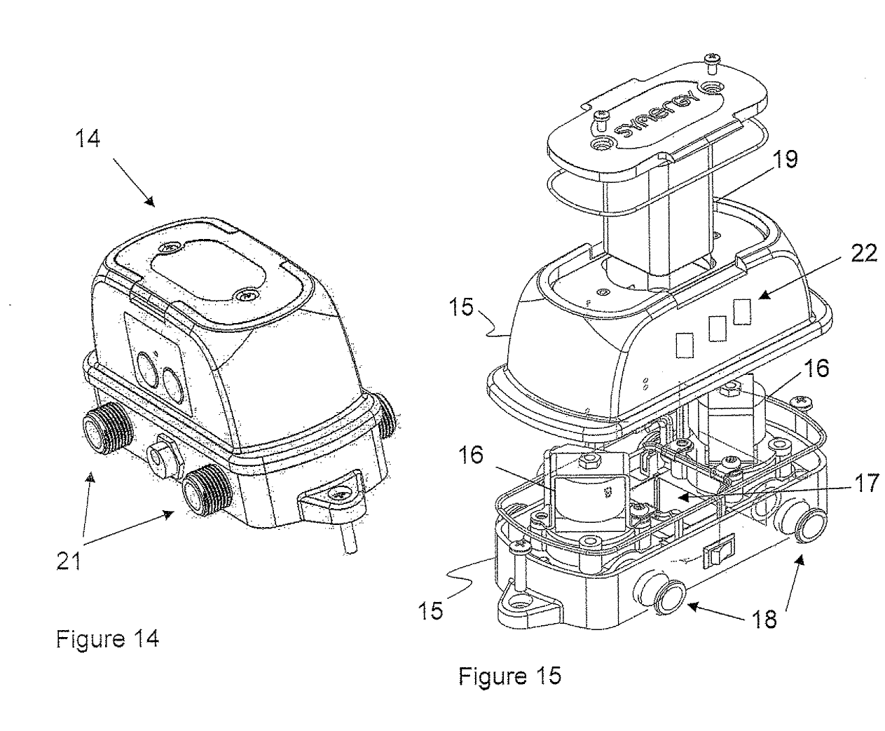

FIG. 14 depicts non-limiting, exemplary control unit 14 for controlling flow in accordance to received transmissions from finger-actuated transmitter 3. Referring to FIG. 15, control unit 14 includes a casing 15 for enclosing receiver circuitry 17 operative to receive a transmission signal and activate solenoid actuated valves 16, and batteries 19 for powering receiver circuitry 17 and solenoid actuated valves 16. Hot and cold water is fed into water inlets 18 and exit unit 14 by way of water outlets 21 visible in FIG. 14. In a non-limiting, exemplary embodiment, control unit 14 is configured to operate at 2.4 GHZ. Each solenoid actuated valve 16 is operative on 6 volts DC in accordance with the signal received by receiver circuitry 17. In a non-limiting exemplary embodiment, receiver circuitry is implemented as a printed circuit board powered by 7.5 volts supplied by 4 AA batteries of 1.5 volts and has a 200 milli-second response time. It should be noted that control unit 14 is also operative on a gridded power supply.

Regarding operation, in a non-limiting, exemplary, control unit 14 is configured such that solenoid actuated valves 16 remain in the state to which they were activated. In other words, if solenoid actuated valves 16 are closed, they open upon receipt of a transmission signal and remain open until receipt of the next transmission. Conversely if open, solenoid actuated valves 16 closes upon receipt of a second transmission signal and remains closed until receipt of another transmission. It should be appreciated that configurations in which solenoid actuated valves 16 are biased to close automatically after a predefined period of time from receipt of a transmission signal are also included within the scope of the present invention. Temperature settings are set one time by adjusting the faucet knobs; no further temperature adjustment is required as long as the use desires water to be dispensed at the same temperature. The system is configurable to dispense either hot or cold water, or a combination of both of them by way of user interface disposed on control unit 14 or disposed in transmitter 3. The particular dispensing mode is displayed on user interface 22. This feature has special significance in regards to the safety of children or the handicapped.

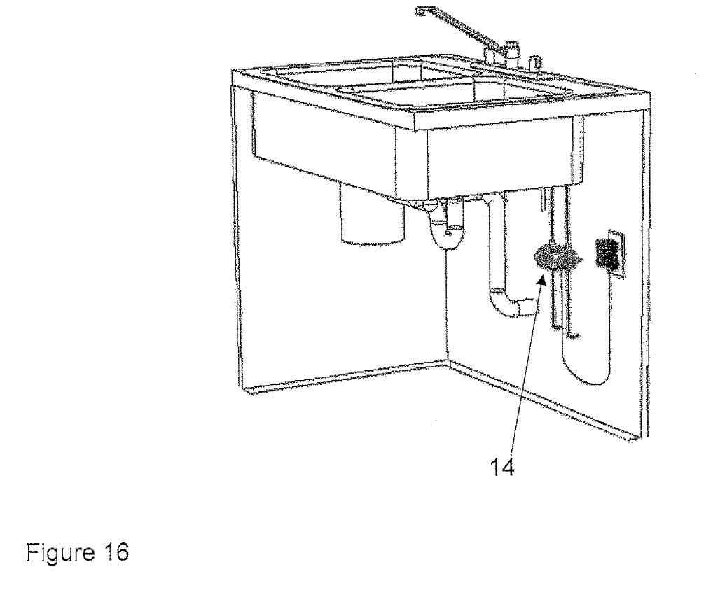

FIG. 16 depicts control unit 14 deployed in a non-obtrusive manner underneath a sink. The hot and cold water inlets 18 and outlets 21 are fitted with standard couplings to facilitate deployment in settings employing standard plumbing. Control unit 14 is easily mountable on a wall without the assistance of professional and specialized services or tools.

The present invention has application in kitchens, bathrooms, personal clinics where hygiene is highly important, professional kitchens, institutions and living quarters for the handicapped incapable of reaching the water faucet but are capable of reaching a sink. Accordingly, the present invention is also useful for physicians, surgeons, or others whose hands are frequently occupied making it awkward to access water tap knobs.

Furthermore, the present invention has shown to provide up to 70% water savings in water usage during dish washing, face washing, brushing teeth, shaving, and bathing children. This water savings also causes savings in reduced water heating costs and helps users develop long term, efficient water consumption habits. The ability to dispense water without touching the handles enhances hygiene and reduces the transmittal of infectious diseases or other illnesses, as mentioned above.

It will be appreciated that the above descriptions are intended only to serve as examples, and that many other embodiments are possible within the scope of the present invention as defined in the appended claims.

What is claimed is:

1. A water dispensing system comprising:
(a) a receiver-actuated water valve connected to a water supply in fluid connection with a water tap; and
(b) a submersible, hand-held device used in conjunction with tap water; and
(c) a transmitter in wireless communication with said receiver-actuated water valve, said transmitter being connected to said device, so as to enable a user holding said device to dispense water from the water tap with the hand holding said device.

2. The remote-controlled, water dispenser system of claim 1, wherein said transmitter includes a connection configuration for retrofitting said transmitter onto said hand-held device.

3. The remote-controlled water dispenser of claim 2, wherein said connection configuration includes at least one clip configured to hold said transmitter on said hand-held device.

4. The remote-controlled water dispenser system of claim 2, wherein said connection configuration is selected from the group consisting of a suction arrangement and adhesive material.

5. The remote-controlled water dispenser system of claim 1, wherein said hand held device includes a toothbrush.

6. The remote-controlled water dispenser system of claim 1, wherein said hand held device includes a non-electric razor.

7. The remote-controlled water dispenser system of claim 1, wherein said hand-held device includes a sponge.

8. The remote-controlled water dispenser system of claim 1, wherein said device is selected from the group consisting of comb, hand peeler and water pitcher.

9. A method for remotely dispensing water from water tap comprising:
(a) holding a submersible, hand-held device used in conjunction with tap water, wherein said device has a transmitter in wireless communication with receiver-actuated water valve configured to allow water flow from a water supply to a water tap; and
(b) actuating said transmitter to dispense water from the water tap with a hand holding said device.

10. The method for remotely dispensing water from a water tap of claim 9, further comprising closing said water valve by re-actuating said transmitter.

11. The method for remotely dispensing water from a water tap of claim 9, wherein said transmitter includes a connection configuration for retrofitting said transmitter onto said device.

12. The method for remotely dispensing water from a water tap of claim 9, wherein said connection configuration includes at least one clip configured to hold said transmitter on said device.

13. The method for remotely dispensing water from a water tap of claim 9, wherein said connection configuration is selected from the group consisting of a suction arrangement and adhesive material.

14. The method for remotely dispensing water from a water tap of claim 9, wherein said hand-held device includes a toothbrush.

15. The method for remotely dispensing water from a water tap of claim 9, wherein said hand-held device includes a non-electric razor.

16. The method for remotely dispensing water from a water tap wherein said hand-held device includes a sponge.

17. The method for remotely dispensing water from a water tap of claim 9, wherein said hand-held device is selected from the group consisting of comb, hand peeler and water pitcher.

18. A water dispensing system comprising:
(a) a receiver-actuated water valve connected to a water supply in fluid connection with a water tap; and
(b) a bath mat
(c) a foot-actuated transmitter in wireless communication with said receiver-actuated water valve, said transmitter being attached to a bath mat so as enable a user to dispense water from the water tap by stepping on said transmitter while standing on said bath mat.
